(19) United States
(12) Patent Application Publication
(10) Pub. No.: US 2010/0030616 A1
(43) Pub. Date: Feb. 4, 2010

(54) APPARATUS AND METHOD FOR CONDUCTING SURVEYS

(76) Inventor: Walter H. Criner, Houston, TX (US)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/181,810

(22) Filed: Jul. 29, 2008

(51) Int. Cl. G06Q 90/00; G06F 17/30

(52) U.S. Cl. 705/10; 235/376

(57) ABSTRACT

A system and method for collecting and analyzing data in real-time across a geographical area. The data is collected by different evaluators using a portable wireless device, and transmitted to a central database in real-time. The data can be reviewed at different levels as soon as it is available on the database. Unacceptable data can be immediately identified so that it can be obtained again. The data can be analyzed and a report subsequently produced.

### BACKGROUND OF THE INVENTION

1. Technical Field

The present invention relates to data collection and analysis systems and, more particularly, to a system for integrating data collection and analysis between a number of participants in real-time.

2. Description of the Related Art

Data collection is often an important part of various projects. In particular certain tasks cannot be initiated until all the necessary data has been collected. This task can be very complicated and daunting to perform when data must be collected across a very large geographical area. Depending on the amount of area to be covered, a large number of data collectors (or evaluators) may be required to in order to distribute the data collection into manageable tasks that can be completed within a reasonable time span.

Organizing data collected by multiple evaluators can create additional problems in terms of synchronization. Since the evaluators are distributed across a large geographical area, time is wasted waiting for all the data to arrive at a single location for review and analysis. Furthermore, if the data collected is unacceptable, the evaluator must return to the assigned geographic area and repeat the data collection process. Next, the data must be returned to the central location where it is being reviewed and analyzed.

A significant amount of time can be lost due to such inefficiencies. In particular, when the geographical area is large, a lot of time can be lost due to inaccurate or erroneous data. This can amount to costly delays to clients. Furthermore, the inability to interact in real-time as a team can create additional complications for reviewing and analyzing the data collected by all evaluators.

Accordingly, there exists a need for a system that allows information to be collected across large geographical areas and evaluated in real-time.

There also exists a need for integrate a group of participants to interact with each other in real-time during the data collection and analysis process.

### SUMMARY OF THE INVENTION

It is therefore one feature and advantage of the present invention to address at least some of the shortcomings of the prior art in integrating the data collection and analysis process.

It is another optional feature and advantage of the present invention to provide a system which allows a team of participants to interact with each other on different levels and in real-time during the data collection process.

It is yet another optional feature and advantage of the present invention to provide a system that allows data collection across large geographical areas in real-time between groups of participants when conducting surveys.

The foregoing, and various other needs, are addressed, at least in part, by the present invention, wherein a method is provided for groups of individuals to conduct surveys and exchange data within the group in real-time.

According to one embodiment of the invention, a method is provided for conducting team surveys. The method comprises the steps of collecting survey data from a plurality of assigned regions using respective portable wireless devices, each of which comprises a web browser and input means; wirelessly transmitting the survey data to a database; accessing the survey data stored in the database using a network terminal; preparing a draft survey report based on acceptance of the survey data; storing the draft survey report to the database; accessing the draft survey stored in the database; reviewing the survey data and draft survey report to identify any errors; preparing a final survey report based on the survey data and draft survey; and storing the final survey report in the database. According to such a method, it is possible to efficiently integrate the data collection process with the entire team in order to reduce time and improve accuracy of the results.

According to further aspects of the invention, if errors are detected in the survey data during review, then the survey data can be rejected before preparing the draft survey report. This provides an opportunity, for example, to request collection of updated survey data from the assigned regions in order to produce an accurate survey report.

According to still further aspects of the invention, collection of the survey data can include shooting at least one photograph with the portable wireless device. Text data describing the photograph, or any aspect of the survey data, can subsequently be added into the portable wireless device. Furthermore, a network can be accessed using a web browser operating on the portable wireless device so that the photographs and text data can be transmitted to the database.

There has thus been outlined, rather broadly, the more important features of the invention and several, but not all, embodiments in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These, together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

FIG. 1 is a block diagram illustrating a survey system according to an exemplary embodiment of the present invention;

FIG. 2 is a flowchart illustrating the steps performed in collecting data for a survey;

FIG. 3 is a diagram illustrating an exemplary group arrangement for conducting a survey according to an exemplary embodiment of the invention;

FIG. 4 is an illustration of a screen display presented for selecting a geographical location during an exemplary survey process;

FIG. 5 is an illustration of a screen display presented for selecting data entry forms during an exemplary survey process;

FIG. 6 is an illustration of a screen display for a questionnaire presented during an exemplary survey process;

FIG. 7 is an illustration of a screen display presented to a reviewer during an exemplary survey process; and

FIG. 8 is an illustration of a screen display presented for preparing a draft report during an exemplary survey process.

### DETAILED DESCRIPTION OF THE INVENTION

Reference now will be made in detail to the presently preferred embodiments of the invention. Such embodiments are provided by way of explanation of the invention, which is not intended to be limited thereto. In fact, those of ordinary skill in the art may appreciate upon reading the present specification and viewing the present drawings that various modifications and variations can be made.

For example, features illustrated or described as part of one embodiment can be used on other embodiments to yield a still further embodiment. Additionally, certain features may be interchanged with similar devices or features not mentioned yet which perform the same or similar functions. It is therefore intended that such modifications and variations are included within the totality of the present invention.

The detailed descriptions which follow may be presented in terms of program procedures executed on a computer, network of computers, or similar devices. These procedural descriptions and representations are the means used by those skilled in the art to most effectively convey the substance of their work to others skilled in the art.

A procedure is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to these quantities.

The present invention also relates to apparatus for performing these operations. This apparatus may be specially constructed for the required purpose or it may include a general purpose computer as selectively activated or reconfigured by a computer program stored in the computer. The procedures presented herein are not inherently related to a particular computer or other apparatus. Various general purpose computing devices (including a desktop, laptop, tablet, PDA, server, etc.) may be used with programs written in accordance with the teachings herein, or it may prove more convenient to construct more specialized apparatus to perform the required method steps. The required structure for a variety of these machines will appear from the description given.

Computer systems upon which an embodiment of the invention may be implemented can typically include hardware such as a bus or other communication mechanism for communicating information, and one or more processors coupled with bus for processing information. The computer system also includes memory, such as a random access memory (RAM) or other dynamic storage device, coupled to bus for storing information and instructions to be executed by the processor. The main memory also may be used for storing temporary variables or other intermediate information during execution of instructions to be executed by processor. The computer system can further include a storage device, such as a magnetic disk or optical disk, that is coupled to the bus for storing information and instructions.

The computer system may be coupled via the bus to a display device, such as a liquid crystal display (LCD), for displaying information to a user. An input device, including alphanumeric and other keys, can be coupled to the bus for communicating information and command selections to the processor. Another type of user input/selection device is a cursor control, such as a mouse, a trackball, or cursor direction keys for communicating direction information and command selections to the processor and for controlling cursor movement on the display. All input devices, and external peripheral devices (e.g., printer, router, switch, etc.) can be connected to the computer system using either wired or wireless interfaces. The computer system also includes a communication interface coupled to the bus. The communication interface provides a two-way data communication coupling to a network link that connects the computer system to one or more networks, such as the internet, local area network (LAN), wide area network (WAN), etc. The communication interface can be configured to provide a wired or wireless connection.

A portable wireless device as described herein can be in the form of various devices, including a PDA or mobile phone integrated with the PDA. Such devices typically include similar features to the previously described computer system, but in a more compact format. For example, the PDA includes a processor coupled to a bus for exchanging and processing information. The PDA system also includes memory (RAM) for storing data and program instructions. Due to its portable size, however, PDA generally incorporate FLASH memory devices for storing data instead of magnetic or optical drives. Additionally, the display and input devices are integrated into the unit. Under certain configurations, a pointer device can be provided in the form of a stylus for use with a touch screen. The PDA also includes a transceiver which allows wireless transmission and reception of signals.

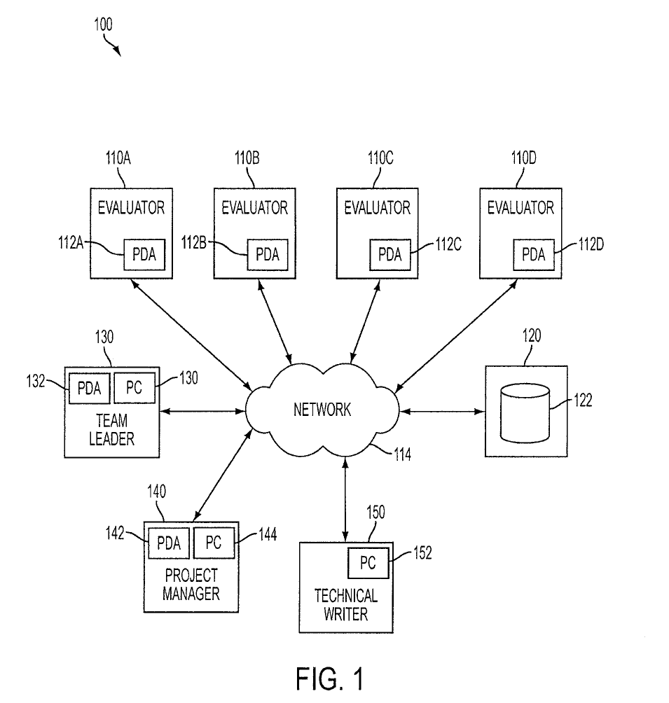

Turning now to FIG. 1, a system 100 is illustrated for conducting group surveys in accordance with at least one embodiment of the present invention. The survey system 100 allows a number of individuals to work together in real-time while covering a diverse and extensive geographical area to collect, review, and analyze data. The individuals participating in the survey can be in different hierarchical groups with different levels of supervision and responsibilities.

According to the exemplary embodiment illustrated in FIG. 1, a plurality of evaluators 110a, 110b, 110c, 110d (collectively 110) examine and collect the necessary data for the survey. Each evaluator 110 utilizes a portable wireless device that includes capabilities for capturing the necessary data and transmitting it to a commonly accessible location. According to at least one embodiment of the invention, the portable wireless device can be in the form of a Personal Digital Assistant (PDA) 112. The PDA 112 provides the evaluator 110 with the ability to input and modify various information pertaining to the survey being conducted. As will be discussed in greater detail below, the PDA 112 includes software which generates various forms to facilitate data entry, and provides navigation features to allow the evaluator 110 to enter, modify, and transmit various information.

The PDA 112 also includes software which allows it to connect to an available network 114, including the Internet. Thus, conventional features for navigating to different websites and locations would be accessible to the evaluator 110. Further, according to one or more embodiments of the invention, the PDA 112 runs a mobile version of the Windows operating system, and the web browser provided with the PDA is a mobile version of Internet Explorer, or based in part on Internet Explorer. According to such an embodiment, the appearance, navigation and conventional features of the browser will be familiar to any evaluator 110 conducting the survey. Additionally, information can be easily exchanged with a desktop version of Internet Explorer because of the common platform.

Each evaluator 110 is assigned to a specific portion of the geographic area being surveyed. Information pertaining to the locations being assigned can be retrieved directly from the PDA 112 using the various menus and forms provided by the operating software. The evaluators 110 collect the data and enter it directly to the PDA 112 using various input methods including touch screens, keypads, gestures, etc. According to one or more embodiments of the invention, the data being collected includes both textual and picture data. In such situations, the PDA 112 is preferably equipped with a built-in camera that allows the evaluator 110 to take the necessary survey pictures, save them directly to the PDA 112, and subsequently transmit them across the network 114. All survey data collected by the evaluators 110, is stored in a central computer 120 that includes, at least a database system and/or other storage device, such as a magnetic or optical drive 122. Although a central computer is independently discussed, it should be noted that a single computer can be configured for access and use by multiple users while also performing the task of the central computer. Thus, all survey information collected by the individual evaluators 110 can be accessed by other evaluators and/or team members.

The survey system 100 includes a team leader 130, who is assigned to oversee a group of evaluators 110. Although FIG. 1 illustrates a single team leader 130, it should be noted that depending on the specific implementation of the invention, multiple team leaders can also be included. The team leader 130 is capable of working directly at the specific geographical location where the evaluators 110 are collecting the data, or at a central location, or any remote location that provides them access to the network 114. The team leaders 130 are capable of accessing survey data transmitted to the central computer 120 using either a PDA device 132 similar, or identical, to those used by the evaluators 110, or the team leader can access the information using a conventional computer 134 (e.g., desktop, laptop, tablet, etc.). The team leader 130 is capable of reviewing the survey data collected by the evaluators 110, and making any changes necessary to prepare a draft survey report. The team leader 130 is also responsible for reviewing the survey data and identifying any inconsistencies or problems. Any information prepared or revised by the team leader 130 is also transmitted to the central computer 120 via the network 114.

A project manager 140 is assigned to one or more team leaders 130 at a higher hierarchy level. Similar to the team leader 130, the project manager 140 is capable of accessing all the survey data stored in the central computer 120, as well as the draft survey prepared by the team leaders 130. The project manager 140 can use a PDA 142 having wireless connectivity to facilitate access of the central computer 120 through the network 114. Furthermore, the PDA 112 can be similar to, or identical to, the team leader PDA 132 or the evaluator PDA 112. Alternatively, the project manager 140 can access the information using a PC 144.

The project manager 140 is responsible for reviewing the draft survey prepared by the team leader 130 and making any necessary changes. The project manager 140 can also review the survey data collected by the evaluators 110. Based on these reviews, the project manager 140 can request additional information from either the team leader 130 or the evaluators 110. All changes made to the draft survey by the project manager 140 are transmitted to the central computer 120 via the network 114. Depending on the size of the geographical area, or the specific type of survey being conducted, multiple project managers can also be used.

A technical writer 150 is assigned to review the draft survey approved by the project manager 140 and produce a final survey report. Accordingly, the technical writer 160 can utilize a PC 152 to gain access to the central computer 120 via the network 114. The technical writer 150 can also perform different types of review of the data and the draft survey, and request additional information from the project manager 140. Once the final survey report is prepared, it can be published in PDF format and provided to a client or for whatever necessary need there may be.

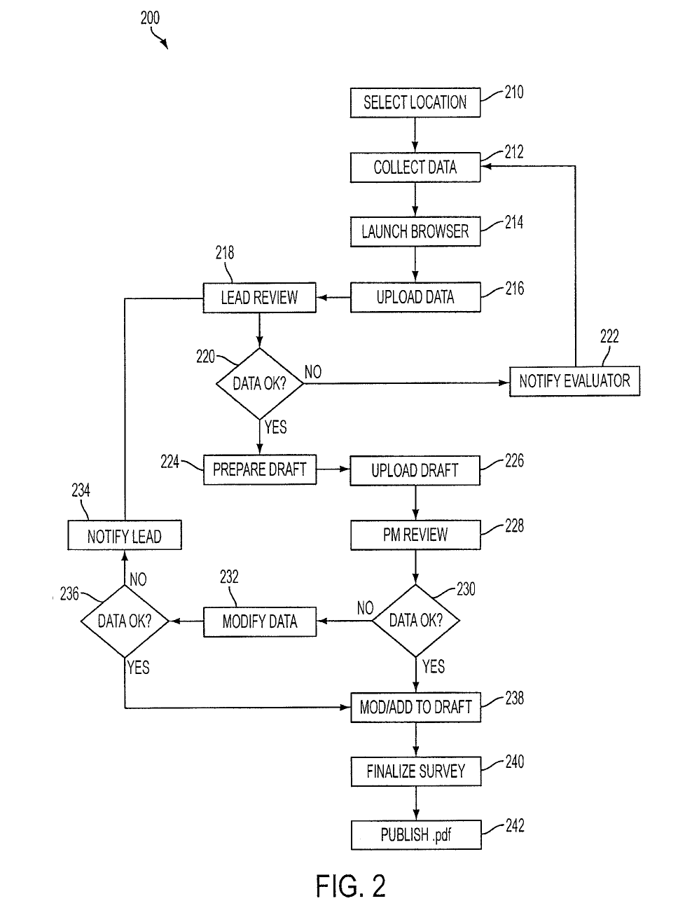

FIG. 2 is a flowchart illustrating the steps performed when conducting surveys in accordance with one or more embodiments of the present invention. At step 210, a location is selected for collecting survey data. The location is selected by an evaluator 110 in various ways. For example, a message can be transmitted directly to the PDA 112 of a specific evaluator 110 identifying the location to be surveyed. Alternatively, for example, the evaluator 110 can access information stored on the central computer 120 and retrieve information pertaining to their assigned location directly from the central computer 120.

At step 212, the evaluator 110 collects survey data for his assigned region. As previously discussed, the survey data can be a combination of text and/or images. The evaluator 110 stores all the selected survey data directly onto the PDA 112. At step 214, the evaluator launches the web browser stored on the PDA 112, or whatever software enables connection to the network. At step 216, the collected survey data (both text and images) are uploaded to the central computer 120 via the network 114. The survey data can be transmitted according to conventional methods, including directing the web browser to a specific location corresponding to the central computer 120, and attaching the files to be uploaded using the browser. Each evaluator 110 can optionally notify the team leader 130 that collection of the survey data has been completed.

At step 218, the team leader 130 reviews the survey data to determine if all the information is correct and/or accurate. At step 220, the team leader 130 determines whether the survey data received from the evaluators 110 is acceptable. If the survey data is not acceptable, then the team leader 130 notifies the evaluator 110 at step S222. The evaluator would then repeat the process of collecting data at step 212. Optionally, if only part of the data is unacceptable, then the evaluator 110 need only collect new data to replace the unacceptable data.

If the team leader 130 determines the survey data to be acceptable, then a draft survey report is prepared at step 224. At step 226, the draft survey report is uploaded to the central computer 120. Once the draft survey report has been uploaded, the team leader 130 can optionally contact the project manager to indicate that the draft survey report is ready for review. Optionally, the project manager 140 can independently check to determine if the draft survey report has been uploaded. The project manager 140 reviews the survey data at step 230. If there are problems or inaccuracies present in the data, then the project manager 140 can modify the survey data at step S232. The data is again checked at step 236. If additional problems exist, then the project manager 140 notifies the team leader 130 at step 234. This would cause the team leader 130 to once again review the survey data and determine if the evaluators 110 must be notified to obtain new data to replace the unacceptable data. If the survey data is determined to be okay by the project manager 140, either in its original form or modified form, then the project manager 140 reviews the draft survey report and makes any corrections or additions at step 238.

At step 240, the technical writer 150 reviews the draft survey and prepares a final survey report. Optionally, the technical writer 150 can request changes and/or additional information from the project manager 140. At step 242, the final survey report is published in PDF format.

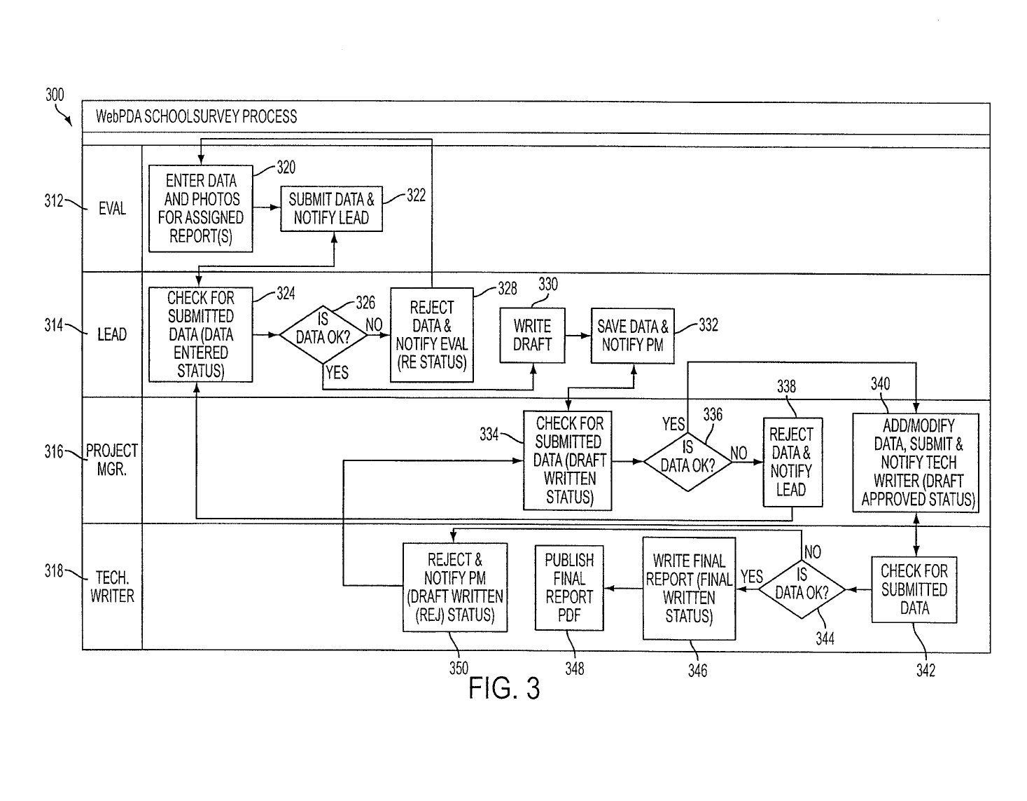

FIG. 3 illustrates a hierarchical and process arrangement 300 for conducting a school survey using the survey system of the present invention. The hierarchical arrangement illustrates one or more evaluators 312 on the first level, team leaders 314 on the second level, project managers 316 on the third level, and the technical write on the fourth level. In order to conduct the survey, the evaluators initially are assigned the specific regions or schools to survey.

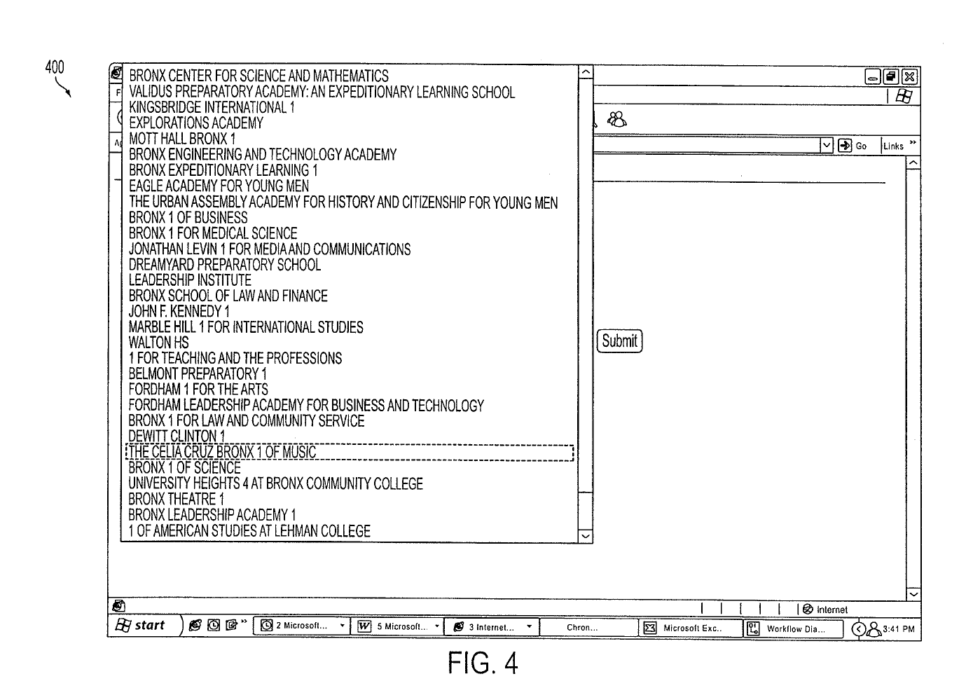

Referring additionally to FIG. 4, the evaluator's PDA can display a list of schools (i.e., geographical locations) from which to select. In such situations, the evaluator may be assigned a specific school by other communication means, such as a text message or email sent directly to the PDA. The evaluator would then select the assigned school from the drop down menu shown in FIG. 4. As can be appreciated, the applications running on the PDA provide the same “look and feel” as the corresponding applications running on a PC. Thus, the screen display shown in FIG. 4 would appear almost identically on the PDA and PC.

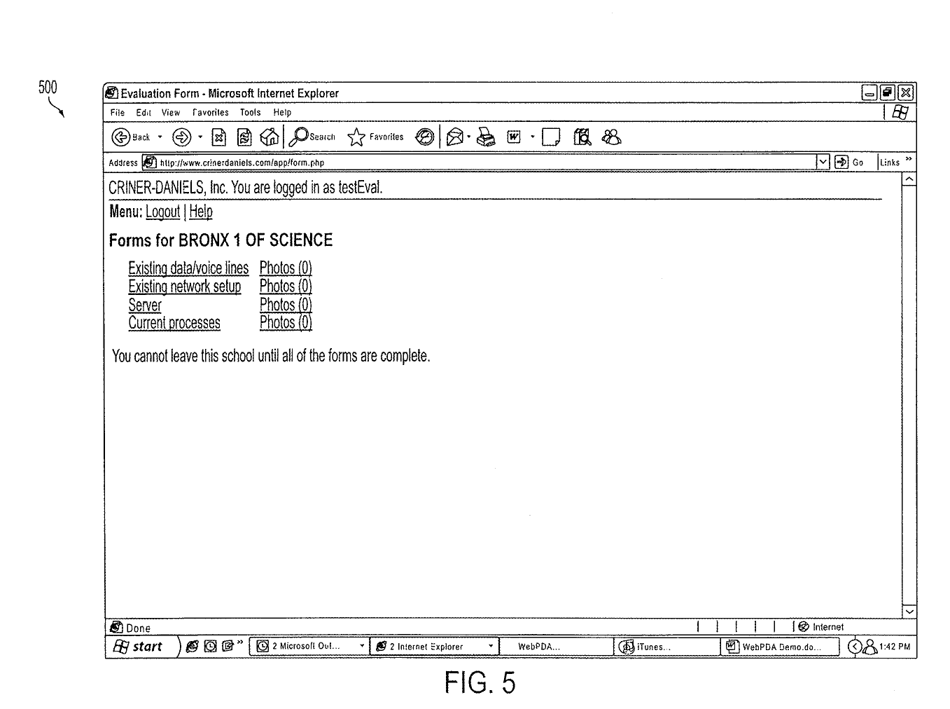

Referring additionally to FIG. 5, once a school has been selected, the evaluator is presented with an option of forms that must be completed as part of the survey. The evaluator can select the forms in any desired order and completed. It should be appreciated that different forms can be prepared and tailored for specific applications. Accordingly, the forms shown in FIG. 5 are only illustrative of the options for completing the school survey.

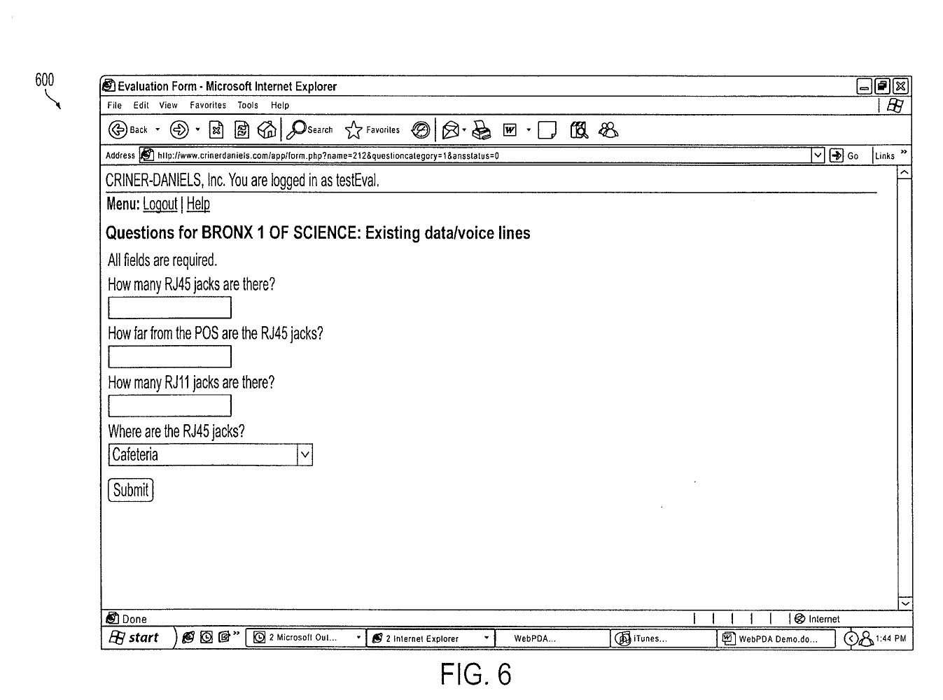

At 320, the evaluators enter survey data in the form of either of text and/or photos. Referring additionally to FIG. 6, the survey forms provide different field types for the evaluator to enter data. For example, certain fields allow the evaluator to enter text corresponding to questions in the form. Other fields provided drop down menus containing predetermined answers from which the evaluator must select. Depending on the type of survey being conducted, the evaluator can optionally take photographs using the PDA and link them to the form or specific fields in the form. Furthermore, depending on the number of fields to be completed, the survey form may be presented across multiple screens on the PDA and PC. The evaluator can optionally return to any form or entry to revise/correct information prior to submitting to the central computer.

Once the evaluator has completed the form, it is submitted to the central computer at 322 and the team leader is notified that the data has been uploaded. Depending on the specific implementation, the team leader can be notified directly by the evaluator using a text message, electronic mail, page, etc. Alternatively, the central computer can be configured to automatically notify the appropriate team leader once an evaluator has submitted a survey. The team leader checks the entered data at 326 to determine if it is okay.

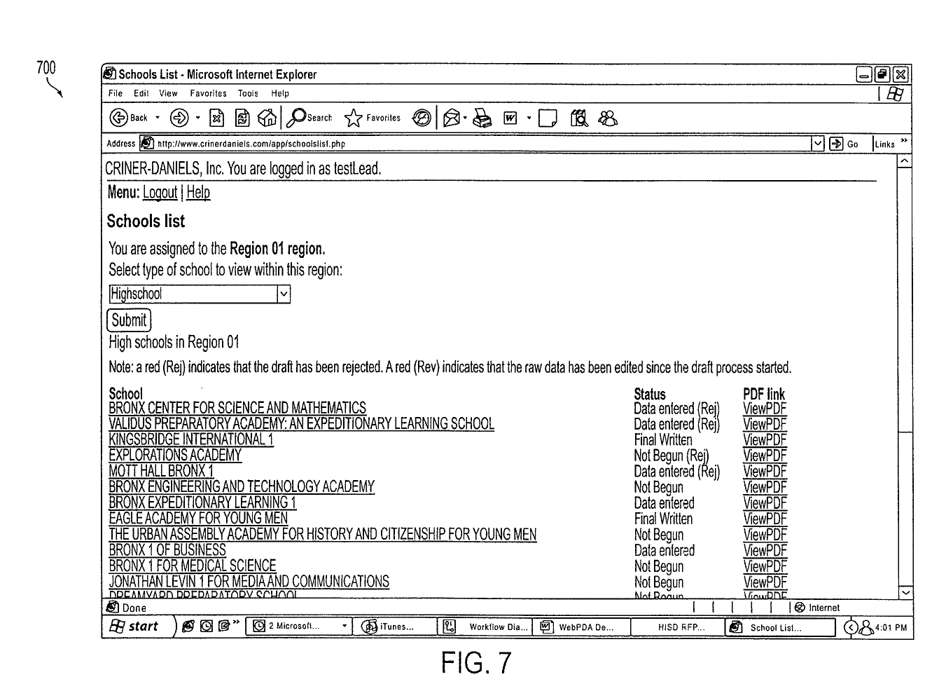

Referring additionally to FIG. 7, the team leader is presented a screen that identifies all the schools to be examined by evaluators as part of the survey. The team leader is able to quickly determine the status of each school's survey. Specifically, the team leader can see if the survey has begun, data has been entered, draft survey written, final survey written, etc. The team leader can also retrieve a PDF version of the documents for review. Any school that is identified with “data entered” can be reviewed and analyzed by the team leader. If the survey data is not okay, the team leader rejects it and notifies the evaluator that the survey data has been rejected at 328. If the survey data is okay, then the team leader prepares a draft survey report at 330.

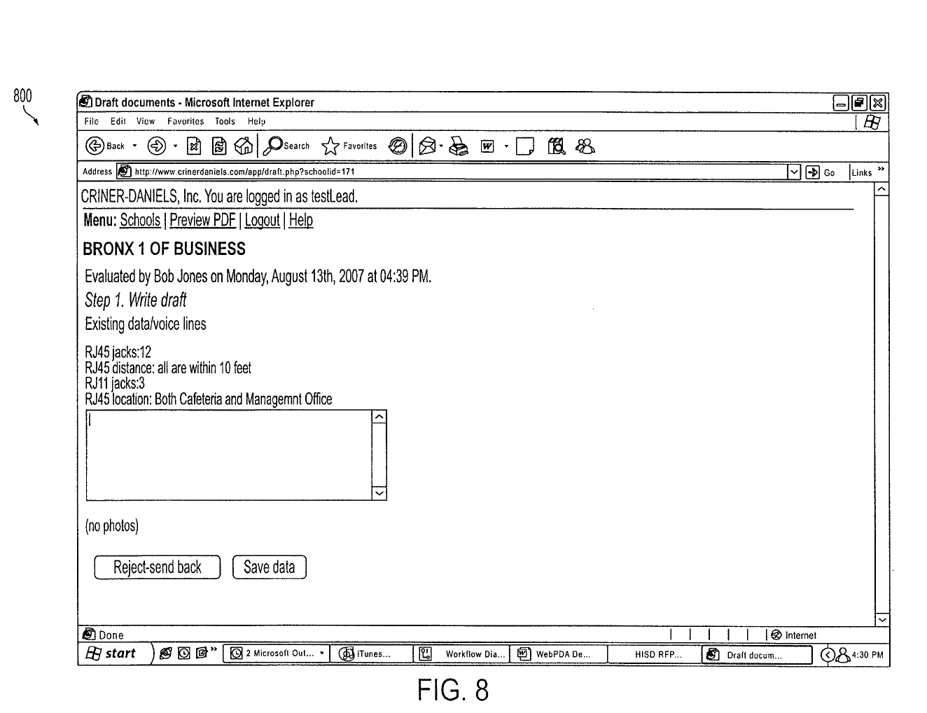

Referring additionally to FIG. 8, the team leader is further presented with a specific screen for preparing the draft survey report. The screen includes a time stamp indicating the time and date when the survey data was submitted, as well as the name of the evaluator who performed the survey. The team leader has the option of rejecting the data or preparing the draft survey report. The draft survey report is saved to the central computer and the project manager is notified at 332.

At 334, the project manager checks to determine if the survey data is present on the central computer, as well as the draft survey report. The project manager also checks to see if the survey data is okay at 336. If the survey data is not okay, then it is rejected at 338 and the project manager notifies the team leader. If the survey data is accepted, then the project manager can add or modify the data or the draft survey report and upload it to the central computer. The technical writer can also be informed that the data and draft survey report have been approved and are ready for finalization. At 342, the technical writer checks to confirm that the survey data, as well as the draft survey report, are present. At 344, the technical writer reviews the data to verify that it is okay. If the data is not okay, then the technical writer rejects the data and informs the project manager that the data has been rejected at 350. If the technical writer rejects the data, then the draft survey report is also rejected. If the data is accepted by the technical writer, then the final survey report is prepared at 346. At 348, the final survey report is published in PDF format.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A method for conducting team surveys comprising the steps of:
collecting survey data from a plurality of assigned regions using respective portable wireless devices, each of which comprises a web browser and input means;
wirelessly transmitting the survey data to a database;
accessing the survey data stored in the database using a network terminal;
preparing a draft survey report based on acceptance of the survey data;
storing the draft survey report to the database;
accessing the draft survey stored in the database;
reviewing the survey data and draft survey report to identify any errors;
preparing a final survey report based on the survey data and draft survey; and
storing the final survey report in the database.

2. The method of claim 1, further comprising the steps of:
rejecting the survey data prior to the step of preparing a draft survey report; and
requesting collection of updated survey data from one or more of the plurality of assigned regions.

3. The method of claim 1, further comprising a step of modifying the survey data after the draft survey has been saved to the database.

4. The method of claim 3 wherein the step of modifying includes at least one of adding, deleting, and editing the survey data.

5. The method of claim 1, wherein the step of collecting survey data further comprises:
shooting at least one photograph with the portable wireless device;
inputting text data into the portable wireless device; and
accessing a network using a browser operating on the portable wireless device for transmission of the at least one photograph and text data.

6. The method of claim 1, wherein the step of wirelessly transmitting comprises wirelessly transmitting the survey data to the database using a browser operating on the portable wireless device.

7. The method of claim 6 wherein the browser is based on Internet Explorer.

8. The method of claim 1, further comprising a step of publishing a final survey report in PDF format.

9. The method of claim 1, wherein the step of preparing a draft survey report is performed by a team leader.

10. The method of claim 1, wherein the step of reviewing the survey data is performed by a project manager.

11. The method of claim 1, wherein the step of preparing a final survey report is performed by a technical writer.

12. A system for conducting surveys comprising:
a plurality of portable wireless devices for collecting data related to the survey from a plurality of locations, each portable wireless device including:
a browser for accessing a network,
a camera device, and
input means for entering information and making selections;
at least one network terminal for accessing data collected using the plurality of portable wireless devices; and
a database in communication with the plurality of portable wireless devices and the at least one network terminal,
wherein:
data collected by the plurality of portable devices is wirelessly exchangeable with the database,
the at least one network terminal is capable of exchanging data with the database, and
the at least one network terminal and the plurality of portable devices are capable of exchanging data via the database.
